(19) United States
(12) Patent Application Publication
(10) Pub. No.: US 2010/0319359 A1
(43) Pub. Date: Dec. 23, 2010

(54) SYSTEM AND METHOD FOR HEATING TURBINE FUEL IN A SIMPLE CYCLE PLANT

(75) Inventors: Joel Donnell Holt, Schenectady, NY (US); Devkinandan Madhukar Tokekar, Schenectady, NY (US)

Correspondence Address: GE Energy-Global Patent Operation;Fletcher Yoder PC, P.O. Box 692289, Houston, TX, 77269-2289, US

(73) Assignee: General Electric Company, Schenectady, NY (US)

(21) Appl. No.: 12/488,123

(22) Filed: Jun. 19, 2009

(51) Int. Cl. F02C 7/224

(52) U.S. Cl. 60/782; 60/736

(57) ABSTRACT

In certain embodiments, a system includes a fuel heater. The fuel heater includes a first heat exchanger configured to receive compressed air from a compressor and to transfer heat from the compressed air to a cooled intermediate heat transfer media to generate a heated intermediate heat transfer media. The fuel heater also includes a second heat exchanger configured to receive the heated intermediate heat transfer media from the first heat exchanger and to transfer heat from the heated intermediate heat transfer media to a fuel. The first heat exchanger is configured to receive the cooled intermediate heat transfer media from the second heat exchanger.

### BACKGROUND OF THE INVENTION

The subject matter disclosed herein relates to the heating of fuel for a simple cycle gas turbine.

Gas turbines in simple cycle plants typically use a mixture of fuel and compressed air for combustion. However, in some instances, the fuel may be at a relatively low temperature whereas the compressed air may be at a relatively high temperature. The low fuel temperature may reduce performance, reduce efficiency, and increase emissions of the gas turbine. Therefore, it may be desirable to heat the fuel before mixing it with the compressed air to improve the performance, efficiency, and emissions of the gas turbine, or to compensate for variations in the fuel constituents.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a gas turbine engine. The gas turbine engine includes a compressor configured to receive and compress air. The gas turbine engine also includes a combustor configured to receive a first flow of the compressed air from the compressor and fuel, wherein the combustor is configured to combust a mixture of the compressed air and the fuel to generate an exhaust gas. The gas turbine engine further includes a turbine configured to receive the exhaust gas from the combustor and to utilize the exhaust gas to rotate a shaft. The system also includes a fuel heating system configured to receive a second flow of the compressed air from the compressor, to heat an intermediate heat transfer media with heat from the second flow of the compressed air, to heat the fuel with heat from the intermediate heat transfer media, and to deliver the fuel to the combustor. The intermediate heat transfer media flows exclusively within the fuel heating system.

In a second embodiment, a system includes a fuel heater. The fuel heater includes a first heat exchanger configured to receive compressed air from a compressor and to transfer heat from the compressed air to a cooled intermediate heat transfer media to generate a heated intermediate heat transfer media. The fuel heater also includes a second heat exchanger configured to receive the heated intermediate heat transfer media from the first heat exchanger and to transfer heat from the heated intermediate heat transfer media to a fuel. The first heat exchanger is configured to receive the cooled intermediate heat transfer media from the second heat exchanger.

In a third embodiment, a method includes heating an intermediate heat transfer media within a first heat exchanger using compressed air from a compressor as a first heat source. The method also includes heating fuel within a second heat exchanger using the heated intermediate heat transfer media from the first heat exchanger as a second heat source. The method further includes circulating the intermediate heat transfer media in a closed loop having the first heat exchanger and the second heat exchanger.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an exemplary embodiment of a simple cycle turbine system having a fuel heating system;

FIG. 2 is a cross sectional side view of an exemplary embodiment of the simple cycle turbine system, as illustrated in FIG. 1;

FIG. 3 is a schematic flow diagram of an embodiment of the simple cycle turbine system and fuel heating system of FIG. 1;

FIG. 4 is a schematic flow diagram of another embodiment of the simple cycle turbine system and fuel heating system of FIG. 1; and

FIG. 5 is a flow chart of an embodiment of a method for heating fuel in the fuel heating system using heated air from a compressor of the simple cycle turbine system as a heat source.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments include systems and methods for heating fuel for a simple cycle gas turbine using heated air from a compressor of the simple cycle gas turbine as the source of heat. For instance, in certain embodiments, compressed air from the compressor may be directed into a first heat exchanger, where the compressed air is used to heat an intermediate heat transfer media, such as water. In addition, the intermediate heat transfer media may include brine, oil, Freon, inert gas, water-glycol, synthetic organic based fluids, alkylated aromatic-based heat transfer fluid, and so forth. Next, the heated intermediate heat transfer media from the first heat exchanger may be directed into a second heat exchanger, where the heated intermediate heat transfer media is used to heat fuel before the fuel is delivered to the simple cycle gas turbine for combustion. Finally, the cooled intermediate heat transfer media from the second heat exchanger may be directed back into the first heat exchanger, where it may be heated by the heated air from the compressor of the simple cycle gas turbine. In addition, in certain embodiments, a thermal storage device may be used to temporarily store the intermediate heat transfer media being transferred to and from the first and second heat exchangers. The use of an intermediate heat transfer media reduces the possibility of combining compressed air and fuel in the first and second heat exchangers. Furthermore, the need for external heat transfer equipment (e.g., auxiliary boilers, oil bath heat exchangers, electric dewpoint heaters, catalytic heaters, and so forth) may be reduced or even eliminated. Alternate heat exchanger configurations may also be used, including various intermediate heat transfer media.

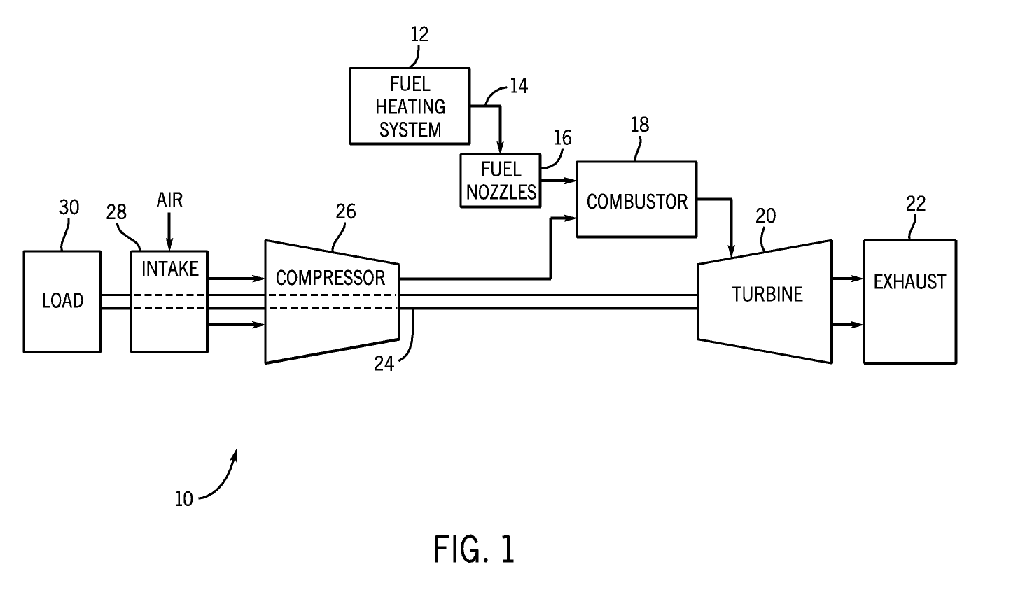

FIG. 1 is a schematic flow diagram of an embodiment of a simple cycle turbine system 10 having a fuel heating system 12. As described in greater detail below, the fuel heating system 12 may be configured to heat fuel 14 before delivering the fuel 14 to the simple cycle turbine system 10. In particular, the fuel heating system 12 may include a first heat exchanger for heating an intermediate heat transfer media with heated, compressed air from a compressor of the simple cycle turbine system 10 and a second heat exchanger for heating the fuel 14 with the heated intermediate heat transfer media from the first heat exchanger.

The simple cycle turbine system 10 may use liquid or gas fuel 14, such as natural gas and/or a hydrogen rich synthetic gas. As depicted, a plurality of fuel nozzles 16 intakes the fuel supply 14, mixes the fuel with air, and distributes the air-fuel mixture into a combustor 18. The air-fuel mixture combusts in a chamber within the combustor 18, thereby creating hot pressurized exhaust gases. The combustor 18 directs the exhaust gases through a turbine 20 toward an exhaust outlet 22. As the exhaust gases pass through the turbine 20, the gases force one or more turbine blades to rotate a shaft 24 along an axis of the simple cycle turbine system 10. As illustrated, the shaft 24 may be connected to various components of the simple cycle turbine system 10, including a compressor 26. The compressor 26 also includes blades that may be coupled to the shaft 24. As the shaft 24 rotates, the blades within the compressor 26 also rotate, thereby compressing air from an air intake 28 through the compressor 26 and into the fuel nozzles 16 and/or combustor 18. The shaft 24 may also be connected to a load 30, which may be a vehicle or a stationary load, such as an electrical generator in a power plant or a propeller on an aircraft, for example. The load 30 may include any suitable device capable of being powered by the rotational output of simple cycle turbine system 10.

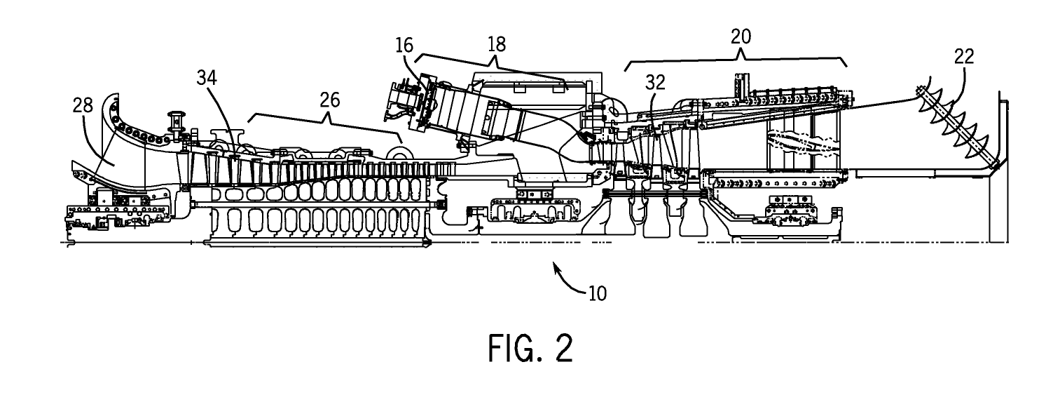

FIG. 2 is a cross sectional side view of an exemplary embodiment of the simple cycle turbine system 10, as illustrate in FIG. 1. The simple cycle turbine system 10 includes one or more fuel nozzles 16 located inside one or more combustors 18. In operation, air enters the simple cycle turbine system 10 through the air intake 28 and is pressurized in the compressor 26. The compressed air may then be mixed with gas for combustion within the combustor 18. For example, the fuel nozzles 16 may inject a fuel-air mixture into the combustor 18 in a suitable ratio for optimal combustion, emissions, fuel consumption, and power output. The combustion generates hot pressurized exhaust gases, which then drive one or more blades 32 within the turbine 20 to rotate the shaft 24 and, thus, the compressor 26 and the load 30. The rotation of the turbine blades 32 causes a rotation of the shaft 24, thereby causing blades 34 within the compressor 26 to draw in and pressurize the air received by the air intake 28.

Returning to FIG. 1, the simple cycle turbine system 10 may be operated using fuel 14 from the fuel heating system 12. In particular, the fuel heating system 12 may supply the simple cycle turbine system 10 with fuel 14, which may be burned within the combustor 18 of the simple cycle turbine system 10. The fuel 14 may include liquid fuel, gas fuel, or a combination thereof. To ensure efficient combustion of the fuel 14 within the combustor 18 of the turbine 12, in certain embodiments, the fuel heating system 12 may include equipment for heating the fuel 14 before delivering the fuel 14 to the combustor 18. More specifically, by heating the fuel 14 before delivering the fuel 14 to the combustor 18, the performance, efficiency, and emissions of the simple cycle turbine system 10 may be improved. Also, in certain embodiments, controlled variable heating of the fuel 14 may be used to compensate for variations in the constituents of the fuel 14, which may affect the energy density of the fuel 14 and subsequently affect emissions, combustion stability, and other combustion dynamics, which may in turn impact hardware life.

One solution for heating the fuel 14 is to use auxiliary heat sources, such as auxiliary boilers, oil bath heat exchangers, electric dewpoint heaters, or catalytic heaters, which generally use steam, gas, or electricity as the source of heat. However, using these types of equipment to heat the fuel 14 may involve certain drawbacks. For example, the capital cost of installing equipment for utilizing auxiliary heat sources may not be the most efficient use of resources in that the auxiliary equipment may generally be larger than what is actually needed. The embodiments disclosed herein are generally directed toward addressing these drawbacks. In particular, as described in greater detail below, the disclosed embodiments provide for using heated, compressed air from the compressor 26 of the simple cycle turbine system 10 to heat an intermediate heat transfer media which, in turn, may be used to heat the fuel 14 before it is delivered to the combustor 18 of the simple cycle turbine system 10.

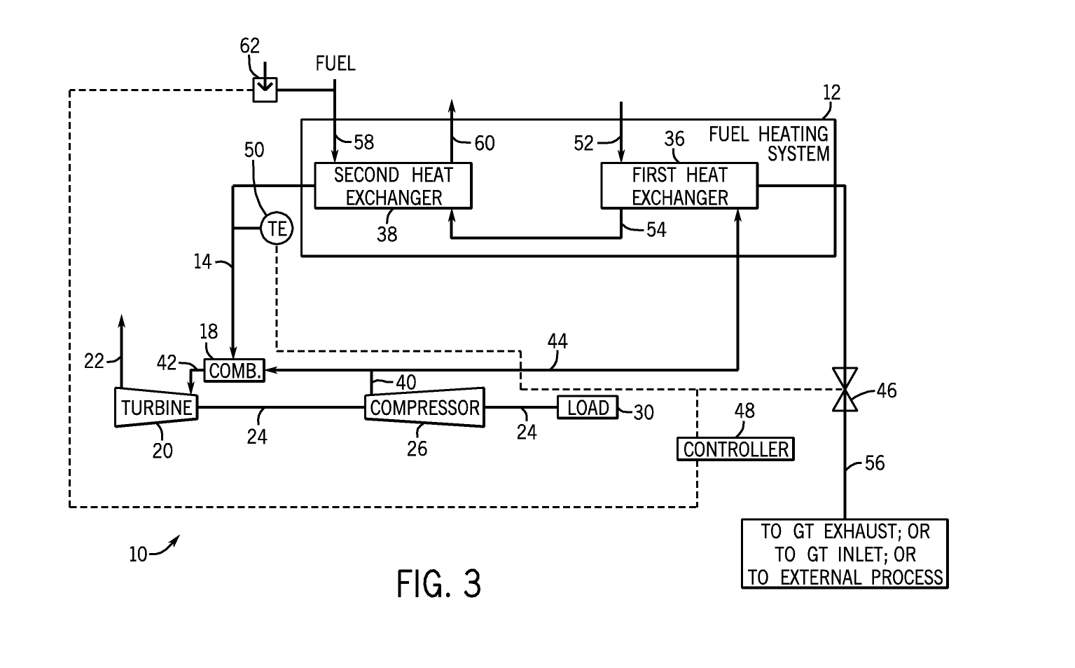

FIG. 3 is a schematic flow diagram of an embodiment of the simple cycle turbine system 10 and fuel heating system 12 of FIG. 1. As illustrated, the fuel heating system 12 may include a first heat exchanger 36 and a second heat exchanger 38. As described in greater detail below, the first heat exchanger 36 may be used to heat an intermediate heat transfer media using heated, compressed air from the compressor 26 of the simple cycle turbine system 10 as a source of heat. In addition, the second heat exchanger 38 may be used to heat fuel using the heated intermediate heat transfer media as a source of heat. Therefore, in general, the fuel heating system 12 may receive heated, compressed air from the compressor 26 of the simple cycle turbine system 10 and may generate heated fuel 14 for use in the combustor 18 of the simple cycle turbine system 10.

To better illustrate the process of heating the fuel 14 with heated, compressed air from the compressor 26 of the simple cycle turbine system 10, an overview of how the simple cycle turbine system 10 generally operates will be described again. As illustrated, the turbine 20 and the compressor 26 may be coupled to the common shaft 24, which may also be connected to the load 30. The compressor 26 also includes blades that may be coupled to the shaft 24. As the shaft 24 rotates, the blades within the compressor 26 also rotate, thereby compressing the inlet air from the air intake 28. The compressed air 40 may be directed into the combustor 18 of the simple cycle turbine system 10, where the compressed air 40 is mixed with the fuel 14 for combustion within combustor 18. More specifically, the plurality of fuel nozzles 16 may inject the air-fuel mixture into the combustor 18 in a suitable ratio for optimal combustion, emissions, fuel consumption, and power output. The air-fuel mixture combusts within the combustor 18, thereby creating hot pressurized exhaust gases 42. The combustor 18 directs the exhaust gases 42 through the turbine 20. As the exhaust gases 42 pass through the turbine 20, the gases force one or more turbine blades to rotate the shaft 24 and, in turn, the compressor 26 and the load 30. More specifically, the rotation of the turbine blades causes rotation of the shaft 24, thereby causing blades within the compressor 26 to draw in and pressurize the inlet air received from the air intake 28.

The compressed air 40 that is generated by the compressor 26 may not only be at an elevated pressure but may also be at an elevated temperature. For instance, in certain embodiments, the compressed air 40 generated by the compressor 26 may be in the range of approximately 500° F. (e.g., at a minimum load on the simple cycle turbine system 10) to 850° F. (e.g., at a maximum load on the simple cycle turbine system 10). However, the temperature of the compressed air 40 may vary between implementations and operating points and may, in certain embodiments, be at least approximately 400° F., 450° F., 500° F., 550° F., 600° F., 650° F., 700° F., 750° F., 800° F., 850° F., 900° F., 950° F., 1000° F., and so forth. In addition, the temperature of the compressed air 40 may vary between different stages of the compressor 26.

Therefore, the compressed air 40 is generally at an elevated temperature, particularly compared to the fuel 14, which may be at ambient temperatures. Therefore, instead of the entire flow of compressed air 40 being directed into the combustor 18 of the simple cycle turbine system 10, a certain amount of the compressed air 40 may be directed or bypassed into the fuel heating system 12 as heated air 44, for use within the first heat exchanger 36 as a source of heat. For example, in certain embodiments, a certain percentage (e.g., approximately 0-20 percent) of the compressed air 40 may be directed toward the first heat exchanger 36. In certain embodiments, the percentage of heated air 44 taken from the main flow of compressed air 40 may be approximately 1% to 3%. However, the percentage of heated air 44 taken from the main flow of compressed air 40 may also vary between implementations and operating points and may, in certain embodiments, be approximately 0.5%, 1.0%, 1.5%, 2.0%, 2.5%, 3.0%, 3.5%, 4.0%, 4.5%, 5.0%, and so forth. These percentages may also be based on various characteristics of the compressed air 40, such as volume, pressure, mass, and so forth. Indeed, in addition to certain percentages being re-directed into the first heat exchanger 36, certain mass flow rates needed to heat the fuel 14 may determine how much heated air 44 should be directed into the first heat exchanger 36.

In certain embodiments, the distribution of the compressed air 40 between the combustor 18 of the simple cycle turbine system 10 and the first heat exchanger 36 of the fuel heating system 12 may be controlled by a valve 46 downstream of the first heat exchanger 36. In particular, the valve 46 may control the amount of heated air 44 to be delivered into the first heat exchanger 36. In certain embodiments, a controller 48 may be used to control the flow of the heated air 44. In particular, the controller 48 may include control logic for actuating the valve 46 to control the flow of the compressed air 40 to the first heat exchanger 36 of the fuel heating system 12. In certain embodiments, the flow of the compressed air 40 and the heated air 44 may be adjusted by the controller 48 based at least in part on conditions within the first heat exchanger 36 and the second heat exchanger 38. For example, the distribution of the compressed air 40 between the combustor 18 and the first heat exchanger 36 may be controlled by the controller 48 based on the temperature of the fuel 14 delivered from the second heat exchanger 38 to the combustor 18, which may be measured by a temperature sensor 50.

As described above, the heated air 44 directed into the first heat exchanger 36 may be used to heat an intermediate heat transfer media 52. The intermediate heat transfer media 52 may be any liquid or gaseous fluid capable of receiving heat from the heated air 44. For example, the intermediate heat transfer media 52 may include water, brine, oil, Freon, inert gas, water-glycol, synthetic organic based fluids, alkylated aromatic-based heat transfer fluid, and so forth. In general, the intermediate heat transfer media 52 heated within the first heat exchanger 36 may be at a substantially lower temperature than the heated air 44 from the compressor 26 of the simple cycle turbine system 10. For example, in certain embodiments, the temperature of the intermediate heat transfer media 52 may be approximately 80° F. to 300° F. However, again, the temperature of the intermediate heat transfer media 52 may vary between implementations and operating points and may, in certain embodiments, be approximately 60° F., 80° F., 100° F., 120° F., 140° F., 160° F., 180° F., 200° F., 220° F., 240° F., 260° F., 280° F., 300° F., 320° F., 340° F., and so forth.

Therefore, the heated air 44 may be used to heat the intermediate heat transfer media 52 to create heated intermediate heat transfer media 54, which may be directed into the second heat exchanger 38. During the process, the heated air 44 will be cooled to a certain degree, generating cooled air 56. In certain embodiments, the cooled air 56 may be directed back into the simple cycle turbine system 10. In particular, the cooled air 56 may be directed into an inlet or exhaust of the simple cycle turbine system 10. More specifically, in certain embodiments, the cooled air 56 may be directed back through the compressor 26 of the simple cycle turbine system 10. However, in other embodiments, the cooled air 56 may be directed to other external processes.

In certain embodiments, the temperature of the intermediate heat transfer media 52 may be increased to approximately 425° F. while the temperature of the heated air 44 may be decreased to approximately 140° F. to 240° F. As before, the amount of heat exchange will vary between implantations and operating points. As such, the temperature of the heated intermediate heat transfer media 54 delivered to the second heat exchanger 38 may vary between approximately 350° F., 375° F., 400° F., 425° F., 450° F., 475° F., 500° F., and so forth, while the temperature of the cooled air 56 may vary between approximately 100° F., 120° F., 140° F., 160° F., 180° F., 200° F., 220° F., 240° F., 260° F., 280° F., 300° F., and so forth. Therefore, in certain embodiments, the temperature of the intermediate heat transfer media 52 may increase by 10, 20, 30, 40, 50, 60, 70, 80, 90, 100%, or more on a Rankine scale, while the temperature of the heated air 44 may decrease by 5, 10, 15, 20, 25, 30, 35, 40, 45, 50%, or more on a Rankine scale.

The heated intermediate heat transfer media 54 directed into the second heat exchanger 38 may be used to heat a source fuel 58. In general, the source fuel 58 heated within the second heat exchanger 38 may be at a substantially lower temperature than the heated intermediate heat transfer media 54 from the first heat exchanger 36. For example, in certain embodiments, the temperature of the source fuel 58 may be approximately 60° F. However, again, the temperature of the source fuel 58 may vary between implementations and operating points and may, in certain embodiments, be approximately 40° F., 50° F., 60° F., 70° F., 80° F., 90° F., 100° F., 110° F., 120° F., and so forth.

Therefore, the heated intermediate heat transfer media 54 may be used to heat the source fuel 58 to create heated fuel 14, which may be directed into the combustor 18 of the simple cycle turbine system 10. During the process, the heated intermediate heat transfer media 54 will be cooled to a certain degree, generating cooled intermediate heat transfer media 60. In certain embodiments, the temperature of the source fuel 58 may be increased to approximately 375° F. while the temperature of the heated intermediate heat transfer media 54 may be decreased to approximately 120° F. As before, the amount of heat exchange will vary between implementations and operating points. As such, the temperature of the heated fuel 14 to be delivered to the combustor 18 of the simple cycle turbine system 10 may vary between approximately 300° F., 325° F., 350° F., 375° F., 400° F., 425° F., 450° F., and so forth, while the temperature of the cooled intermediate heat transfer media 60 may vary between approximately 80° F., 90° F., 100° F., 110° F., 120° F., 130° F., 140° F., 150° F., 160° F., and so forth. Therefore, in certain embodiments, the temperature of the source fuel 58 may increase by 10, 20, 30, 40, 50, 60, 70, 80, 90, 100%, or more on a Rankine scale, while the temperature of the heated intermediate heat transfer media 54 may decrease by 5, 10, 15, 20, 25, 30, 35, 40, 45, 50%, or more on a Rankine scale.

In addition, in certain embodiments, the heated fuel 14 may be controlled using wide wobbe control, which is essentially a method of adjusting the BTU (British thermal unit) content of the fuel 14 to a constant value, thereby compensating for variations in the constituents of the source fuel 58. In particular, in certain embodiments, wide wobbe control may be facilitated using a gas chromatograph or other BTU measurement device 62 and using the controller 48 to adjust the flow rate of the intermediate heat transfer media 52 to ensure that the BTU content of the fuel 14 remains at a generally constant value. Wide wobbe control is described in co-pending U.S. Patent Application Publication No. 2009/0031731, which is hereby incorporated by reference in its entirety.

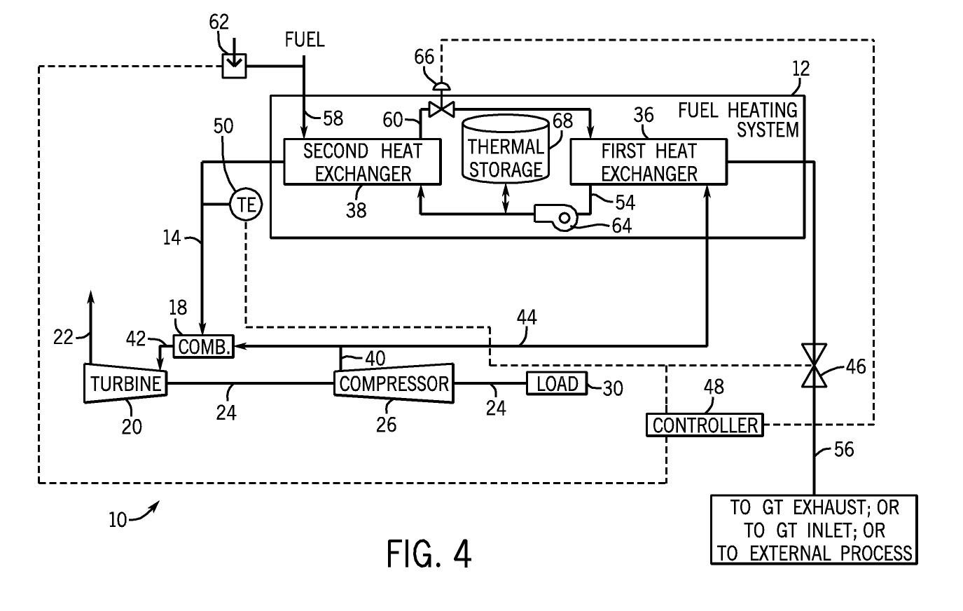

However, the embodiment of the simple cycle turbine system 10 and the fuel heating system 12 described above with respect to FIG. 3 is not the only possible design. For example, FIG. 4 is a schematic flow diagram of another embodiment of the simple cycle turbine system 10 and fuel heating system 12 of FIG. 1. As illustrated, instead of heating intermediate heat transfer media 52 from an external system in the first heat exchanger 36, as in FIG. 3, the cooled intermediate heat transfer media 60 from the second heat exchanger 38 may be heated within the first heat exchanger 36. Therefore, the heated intermediate heat transfer media 54 sent from the first heat exchanger 36 to the second heat exchanger 38 and the cooled intermediate heat transfer media 60 sent from the second heat exchanger 38 to the first heat exchanger 36 may form a closed loop heating and cooling system, whereby the intermediate heat transfer media 54, 60 is alternately heated and cooled by the first and second heat exchangers 36, 38, respectively. In other words, the intermediate heat transfer media 54, 60 may flow exclusively within the fuel heating system 12. More specifically, in certain embodiments, the intermediate heat transfer media 54, 60 may be pumped directly to and from the first and second heat exchangers 36, 38 through dedicated piping, with minimal intervening equipment, using a pump 64. In addition, at least one control valve 66 may be used to control the flow of intermediate heat transfer media 54, 60 within the closed loop system. In certain embodiments, the pump 64 and the control valve 66 may be controlled by the controller 48 to ensure that the correct amount of heat is transferred into the fuel 14. For example, as described above, in certain embodiments, the heat content of the heated fuel 14 may be held relatively constant by, for example, adjusting the amount of heated air 44 directed into the first heat exchanger 36.

Such a closed loop heating and cooling system may prove particularly beneficial for use with the simple cycle turbine system 10 in that it eliminates the need for external heat transfer equipment (e.g., electric heaters) and an external intermediate heat transfer media source (e.g., feedwater from a feedwater system). Using the intermediate heat transfer media 54, 60 in this type of closed loop heating and cooling system may simplify the transfer of heat from the heated air 44 from the compressor 26 of the simple cycle turbine system 10, to the intermediate heat transfer media (e.g., the intermediate heat transfer media 54, 60), to the fuel 14. The intermediate heat transfer media 54, 60 used within the first and second heat exchangers 36, 38 may be any gaseous or liquid fluid suitable for transferring heat from the heated air 44 to the fuel 14. For example, the intermediate heat transfer media 54, 60 may include water, brine, oil, Freon, inert gas, water-glycol, synthetic organic based fluids, alkylated aromatic-based heat transfer fluid, and so forth.

In addition, in certain embodiments, the closed looped heating and cooling system of FIG. 4 may include a thermal storage device 68, such as an insulated storage tank. As such, the heated intermediate heat transfer media 54 from the first heat exchanger 36 may be temporarily stored in the thermal storage device 68 before being directed into the second heat exchanger 38. Storing the heated intermediate heat transfer media 54 in the thermal storage device 68 may be particularly useful for facilitating heating of the fuel 14 during startup of the simple cycle turbine system 10. In addition, in other embodiments, a second or alternate thermal storage device may be used to temporarily store the cooled intermediate heat transfer media 60 from the second heat exchanger 38 before it is directed back into the first heat exchanger 36.

Furthermore, in certain embodiments, the fuel heating system 12 may consist essentially of the first heat exchanger 36, the second heat exchanger 38, and piping to interconnect the first and second heat exchangers 36, 38. In addition, in other embodiments, the fuel heating system 12 may consist essentially of the first heat exchanger 36, the second heat exchanger 38, one or more pumps 64, one or more control valves 66, one or more thermal storage devices 68, and piping to interconnect the first and second heat exchangers 36, 38 and the one or more thermal storage devices 68. In other words, as described above, the fuel heating system 12 may comprise a closed loop system through which the intermediate heat transfer media flows.

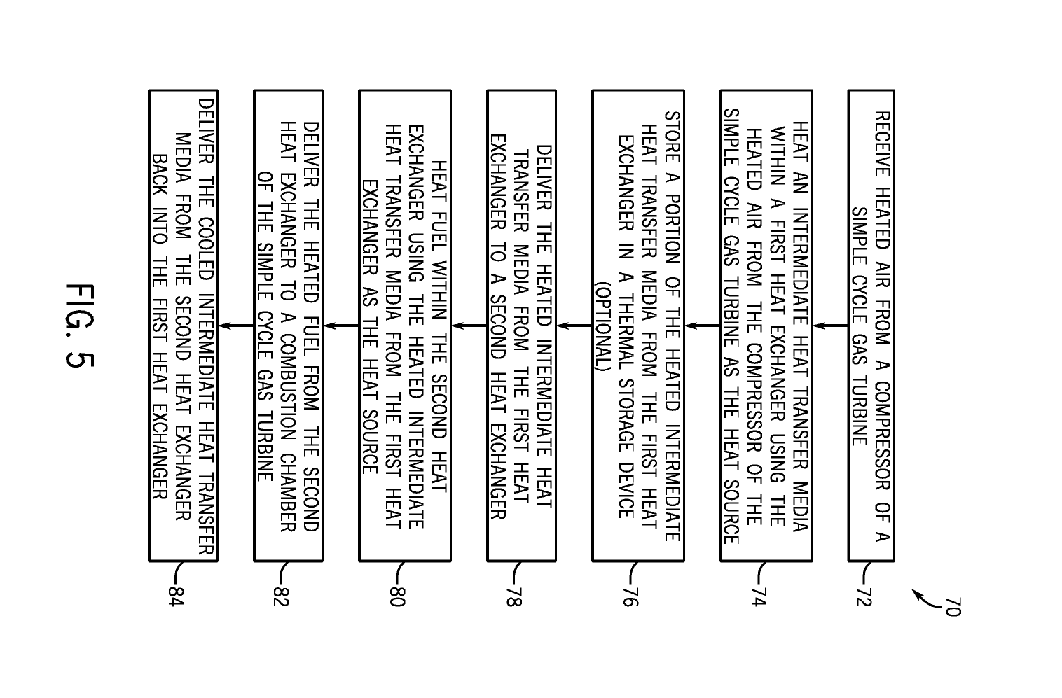

FIG. 5 is a flow chart of an embodiment of a method 70 for heating the fuel in the fuel heating system 12 using the heated air 44 from the compressor 26 of the simple cycle turbine system 10 as a heat source. In step 72, the fuel heating system 12 may receive the heated air 44 from the compressor 26. As described above, the controller 48 may be used to determine how much heated air 44 should be delivered to the fuel heating system 12 for use as a heat source. For example, if the temperature of the fuel 14 measured by the temperature sensor 50 is below a target value, the controller 48 may determine that the amount of heated air 44 delivered to the fuel heating system 12 should be increased. Accordingly, the controller 48 may actuate the valve 46 to increase the flow rate of the heated air 44 into the fuel heating system 12. Conversely, if the temperature of the fuel 14 measured by the temperature sensor 50 is above a target value, the controller 48 may determine that the amount of heated air 44 delivered to the fuel heating system 12 should be decreased and/or the mass flow rate of the intermediate heat transfer media should be reduced by diverting part of the intermediate heat transfer media flow rate into the thermal storage device 68, such as in step 76 described below. Accordingly, the controller 48 may actuate the valve 46 to decrease the flow rate of the heated air 44 into the fuel heating system 12.

As described above, an intermediate heat transfer media may be used for heating the fuel 14. The two-step process of first heating the intermediate heat transfer media with the heated air 44 in the first heat exchanger 36 and then heating the source fuel 58 with the heated intermediate heat transfer media in the second heat exchanger 38 is generally beneficial in that the possibility of creating a combustible air-fuel mixture in the fuel heating system 12 is reduced. In other words, since an intermediate heat transfer media is used, there is less of a chance that the heated air 44 and the source fuel 58 will mix, creating an undesirably combustible situation in the fuel heating system 12.

In step 74, the intermediate heat transfer media may be heated within the first heat exchanger 36 using the heated air 44 from the compressor 26 of the simple cycle turbine system 10 as the heat source. In other words, heat will be transferred from the heated air 44 to the intermediate heat transfer media within the first heat exchanger 36. Any suitable heat exchanger design capable of transferring heat from the heated air 44 to the intermediate heat transfer media may be used. During step 74, the intermediate heat transfer media will be heated to become the heated intermediate heat transfer media 54, which will be directed into the second heat exchanger 38 while the heated air 44 will be cooled to become the cooled air 56. In step 76, a portion of the heated intermediate heat transfer media 54 from the first heat exchanger 36 may optionally be stored in a thermal storage device 68, such as an insulated storage tank. In certain embodiments, the thermal storage device 68 may be used to extract and/or provide heat to and from the closed loop system to help adjust the amount of heat content in the heated fuel 14. For example, in certain embodiments, the controller 48 may be configured to divert and/or extract the heated intermediate heat transfer media 54 and/or the cooled intermediate heat transfer media 60 to and from one or more thermal storage devices 68 to adjust the heat content in the heated fuel 14. Then, in step 78, the heated intermediate heat transfer media 54 from the first heat exchanger 36 may be delivered to the second heat exchanger 38.

In step 80, the source fuel 58 may be heated within the second heat exchanger 38 using the heated intermediate heat transfer media 54 from the first heat exchanger 36 as the heat source. In other words, heat will be transferred from the heated intermediate heat transfer media 54 to the source fuel 58 within the second heat exchanger 38. Any suitable heat exchanger design capable of transferring heat from the heated intermediate heat transfer media 54 to the fuel 14 may be used. During step 80, the source fuel 58 will be heated to become the fuel 14 which will be directed into the combustor 18 of the simple cycle turbine system 10, while the heated intermediate heat transfer media 54 will be cooled to become the cooled intermediate heat transfer media 60 which may be directed back into the first heat exchanger 36.

In step 82, the fuel 14 which has been heated within the second heat exchanger 38 may be delivered to the combustor 18 of the simple cycle turbine system 10. As described above, in certain embodiments, the temperature of the fuel 14 from the second heat exchanger 38 may be monitored by the controller 48 via the temperature sensor 50 to determine whether the flow rate of the heated air 44 into the fuel heating system 12 should be increased, decreased, or maintained at the current flow rate, among other things. Finally, in step 84, the cooled intermediate heat transfer media 60 may be directed back into the first heat exchanger 36.

Technical effects of the disclosed embodiments include providing systems and methods for heating fuel for use in a simple cycle gas turbine using compressed air from a compressor of the simple cycle gas turbine as a source of heat. More specifically, a first heat exchanger may be used to heat an intermediate heat transfer media with the heated, compressed air. Next, the heated intermediate heat transfer media from the first heat exchanger may be directed into a second heat exchanger, where the heated intermediate heat transfer media may be used to heat the fuel. Finally, the cooled intermediate heat transfer media from the second heat exchanger may be directed back into the first heat exchanger, where it may be heated by the heated, compressed air from the compressor of the simple cycle gas turbine.

By using an intermediate heat transfer media, the possibility of combustion of an air-fuel mixture in the first and second heat exchangers is substantially reduced or eliminated. In addition, since existing air from the compressor of the simple cycle gas turbine may be used to heat the fuel, the need for external heat transfer equipment (e.g., auxiliary boilers, electric heaters, and so forth) may be reduced or even eliminated, thereby reducing capital costs, reducing energy consumption, increasing controllability, and maintaining plant efficiency. Furthermore, reducing the need for oil bath heaters as external heat transfer equipment may reduce emissions. It should be noted that other heat exchanger configurations and/or intermediate heat transfer media may be used in conjunction with the disclosed systems and methods.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a gas turbine engine, comprising:
a compressor configured to receive and compress air;
a combustor configured to receive a first flow of the compressed air from the compressor and fuel, wherein the combustor is configured to combust a mixture of the compressed air and the fuel to generate an exhaust gas; and
a turbine configured to receive the exhaust gas from the combustor and to utilize the exhaust gas to rotate a shaft; and
a fuel heating system configured to receive a second flow of the compressed air from the compressor, to heat an intermediate heat transfer media with heat from the second flow of the compressed air, to heat the fuel with heat from the intermediate heat transfer media, and to deliver the fuel to the combustor, wherein the intermediate heat transfer media flows exclusively within the fuel heating system.

2. The system of claim 1, wherein the gas turbine engine is a simple cycle gas turbine engine.

3. The system of claim 1, comprising a valve configured to adjust the second flow of the compressed air to the fuel heating system.

4. The system of claim 3, comprising a controller configured to control the valve based at least in part on the temperature of the fuel from the fuel heating system.

5. The system of claim 1, wherein the fuel heating system comprises a first heat exchanger configured to heat the intermediate heat transfer media with the second flow of compressed air, and a second heat exchanger configured to heat the fuel with the intermediate heat transfer media from the first heat exchanger.

6. The system of claim 1, wherein the fuel heating system comprises a thermal storage device configured to store a portion of the intermediate heat transfer media from the first heat exchanger.

7. The system of claim 1, wherein the fuel heating system comprises a closed loop heating and cooling system.

8. The system of claim 1, wherein the fuel heating system is configured to deliver the second flow of the compressed air to an inlet of the gas turbine engine.

9. The system of claim 1, wherein the intermediate heat transfer media comprises water.

10. A system, comprising:
a fuel heater, comprising:
a first heat exchanger configured to receive compressed air from a compressor and to transfer heat from the compressed air to a cooled intermediate heat transfer media to generate a heated intermediate heat transfer media; and
a second heat exchanger configured to receive the heated intermediate heat transfer media from the first heat exchanger and to transfer heat from the heated intermediate heat transfer media to a fuel;
wherein the first heat exchanger is configured to receive the cooled intermediate heat transfer media from the second heat exchanger.

11. The system of claim 10, wherein the fuel heater is configured to receive the compressed air from a compressor of a simple cycle gas turbine engine.

12. The system of claim 10, wherein the fuel heater comprises a thermal storage device configured to store a portion of the heated intermediate heat transfer media from the first heat exchanger.

13. The system of claim 12, wherein the fuel heater comprises a closed loop heating and cooling system, wherein the cooled intermediate heat transfer media and the heated intermediate heat transfer media flow exclusively between the first and second heat exchangers and the thermal storage device.

14. The system of claim 10, comprising a valve configured to adjust the flow of the compressed air from the compressor to the first heat exchanger.

15. The system of claim 14, comprising a controller configured to control the valve based at least in part on the temperature of the fuel from the second heat exchanger.

16. The system of claim 10, wherein the intermediate heat transfer media comprises water.

17. A method, comprising:
heating an intermediate heat transfer media within a first heat exchanger using compressed air from a compressor as a first heat source;
heating fuel within a second heat exchanger using the intermediate heat transfer media from the first heat exchanger as a second heat source; and
circulating the intermediate heat transfer media in a closed loop having the first heat exchanger and the second heat exchanger.

18. The method of claim 17, comprising storing a portion of the intermediate heat transfer media from the first heat exchanger within a thermal storage device.

19. The method of claim 17, comprising delivering the fuel from the second heat exchanger to a combustion chamber of a simple cycle gas turbine engine.

20. The method of claim 17, comprising controlling the flow of the compressed air between the first heat exchanger and a combustion chamber of a simple cycle gas turbine engine.
